(19) United States
(12) Patent Application Publication
(10) Pub. No.: US 2001/0041209 A1
(43) Pub. Date: Nov. 15, 2001

(54) Cheese sauce and method for producing it

(76) Inventor: Frans Leonard Visee, BB Vortum-Mullen (NL)

Correspondence Address: BROWDY AND NEIMARK, P.L.L.C., 624 NINTH STREET, NW, SUITE 300, WASHINGTON, DC, 20001-5303, US

(21) Appl. No.: 09/780,686

(22) Filed: Feb. 7, 2001

Related U.S. Application Data
(60) Provisional application No. 60/180,683, filed on Feb. 7, 2000.

(51) Int. Cl. A23C 19/09

(52) U.S. Cl. 426/582

(57) ABSTRACT

The present invention relates to a method for the preparation of a cheese sauce and/or a mixture based on cheese that is suitable for the preparation of a cheese sauce by an end user/consumer, which method comprises at least the following steps: (a) the provision of a processed cheese base, in particular a processed cheese base based on fresh cheese; (b) mixing the processed cheese base from step (a) with a roux.

The invention furthermore relates to a cheese product, in particular in the form of a packaged commercial product, that can be processed/reconstituted by the end user to give a cheese sauce according to the invention, for example by adding water and optionally by heating.

The present invention relates to a cheese-based food product.

More particularly, the present invention relates to a cheese-based sauce and to a method for producing it.

The invention furthermore relates to a cheese product, in particular in the form of a packaged retail product which can be processed/reconstituted by the end user to form a cheese sauce according to the invention, for example by adding water and, if appropriate, by heating. The invention also relates to a method for preparing this cheese product.

Currently, cheese sauces are prepared on the basis of processed cheese (powder). According to the invention, a cheese sauce or powder for preparing such a sauce is now produced on the basis of processed cheese and a roux.

A particular advantage of the cheese sauce according to the invention is that it can be prepared with a high cheese content, in particular a high fresh cheese content, which may be 40% by weight or more, and up to 70% by weight of more of the final sauce.

Further advantages of the cheese sauce according to the invention are the easy solubility without any lumps forming; in addition to conventional processing (preparation) of the cheese sauce in the kitchen on the worktop or, for example, the gas cooker, the cheese sauce can also be processed (prepared) in a microwave; there is no separation of moisture and the sauce, once it has been prepared, can be reheated.

Therefore, in a first aspect the application relates to a method for preparing a cheese sauce and/or a cheese-based mixture which is suitable for the preparation of a cheese sauce by an end user/consumer, which method comprises at least the following steps:

a) producing a processed cheese base, in particular a processed cheese base which is based on fresh cheese;

b) mixing the processed cheese base from step a) with a roux.

The processed cheese base obtained in step a) is preferably used in step b) while this base is kept at a temperature of at least 40° C., preferably at least 70° C., and for preference at a temperature of 85 to 110° C. In this case, the method of the invention will generally comprise, after mixing of the roux with/through the processed cheese base, the following further steps:

c) hardening the mixture obtained in step b); and/or

d) comminuting/breaking up the mixture obtained in step b) or step c).

The mixture obtained after step b), and in particular the hardened and comminuted mixture obtained after step c) and/or step d), will generally be sold as a packaged product and/or delivered to the end user/consumer in some other way. The end user will then process this mixture further to form the final cheese sauce according to the invention, in particular by the following steps:

e) adding water or another suitable liquid; and/or

f) stirring and/or heating.

The cheese sauce obtained in this way, as well as the mixture obtained after one of steps b), c) and/or d), in particular in the form of a packaged retail product, form further aspects of the invention.

The processed cheese base used in the method according to the invention will generally be substantially the same as a known processed cheese.

This processed cheese (base) can be prepared in a manner which is known per se, i.e. by mixing one or more cheeses, cheese types and/or cheese constituents with one or more processing salts which are known per se, and any further constituents which are known per se for processed cheese.

In this case, the starting material used may be all cheeses, cheese types and/or cheese constituents which are known per se, including low-fat, standard and full fat cheese types; new, matured or extra mature cheeses; blue-veined cheeses and the like; or a suitable combination thereof, depending on the desired taste of the final sauce.

Preferably, fresh cheeses, cheese types and/or cheese constituents are used.

Examples of suitable cheese types are: Maaslander, Gouda, Edam, Cheddar, Emmenthal, Gruyere, blue cheeses such as Roquefort, Gorgonzola, Danish Blue; or a suitable combination thereof.

Examples of suitable processing salts for use in the processed cheese base include (poly)phosphates, such as the sodium or potassium salts of mono-, di- or polyphosphoric acid; the sodium or potassium salt of citric acid; tartaric acid or salts thereof; lactic acid or salts thereof; malic acid or salts thereof; or other suitable emulsifying salts; or a suitable combination thereof.

Examples of suitable commercially available processing salts (mixtures) are Solva®35 and Solva®120, produced by Giulini.

The processed cheese base may furthermore contain one or more further suitable constituents and/or additions for processed cheeses, such as one or more of:

binders, thickeners and/or stabilizers, for example sodium caseinate, whey proteins or other suitable milk protein preparations; gums such as locust bean gum, guar gum, xanthan gum, carob bean gum, carrageenan gum, alginates, such as E 400-405;

emulsifiers, for example lecithins or fatty acid mono- or diglycerides;

preservatives, for example sorbic acid or its sodium or potassium salts, propionic acid or its sodium or potassium salts, nisin;

colourants, for example annatto extracts; beta-carotene; paprika oleoresin; and flavourings and/or flavour enhancers, for example monosodium glutamate, cheese flavours, cheese powders;

pH regulators, for example a suitable (organic) acid, such as phosphoric acid, citric acid, acetic acid, lactic acid or the sodium or potassium salts thereof; sodium bicarbonate, calcium carbonate; glucono-delta-lactone;

in suitable quantities which are known per se. If appropriate, one or more fats or fat constituents may also be added, in addition to the quantity of fat which is already present from the cheese.

The constituents of the processed cheese will generally be mixed in a suitable mixer or processor; with heating, for example at a temperature of more than 70° C., in particular in the range from 85 to 110° C., for example by using (direct) steam; and if appropriate while mixing or stirring, until a homogeneous mixture is obtained.

In this case, the cheese constituents will generally be supplied to the processor in a broken, chopped, grated, ground or other comminuted/broken-up form. More preferably, the cheese constituents will be squashed/minced prior to processing, for example in a suitable mill or other grinding device; this will promote the formation of a homogeneous processed cheese mixture.

If appropriate, it is also possible for a small quantity of water to be added to the processed cheese mixture/the processor, for example in order to facilitate mixing of the constituents. However, this is not necessary, and the addition of large quantities of water is preferably avoided.

In general, the composition of the processed cheese base will generally be as follows:

| | | |
|---|---|---|
| cheese or cheese constituents: | 1-95% | by weight, preferably |
| | 40-95% | by weight |
| processing salts: | 1-4% | by weight |
| binder: | 2-15% | by weight |
| preservative: | 0-0.25% | by weight |
| water (added) | 0-20% | by weight |
| further additions: | 0-30% | by weight |

where the total of the constituents will be 100% by weight, based on the processed cheese base.

Then, the roux is added to the processed cheese base thus obtained, which is kept in the mixer/processor at a temperature of more than 40° C., preferably more than 70° C., in particular in the range from 85 to 110° C. In this case, the roux will generally have been prepared separately from the processed cheese base and/or in advance, as will now be described.

The roux may be any (binder) mixture which is known per se for preparation of sauces, such as a roux which is used in the industrial preparation of sauces. It is preferable to use a mixture which is based on one or more suitable fats or fats constituents; a flour or meal; and a suitable starch constituent or starch-based additive, for example a modified starch.

The (source of) fats used may, for example, be animal fats, such as: butter, or vegetable fats, such as for example palm oil; or a suitable combination thereof.

The melting point of the fats is preferably in the range from 10 to 40° C., although if appropriate some of the fat fraction may comprise hardened fats with melting points up to 60° C.

Flours which may be mentioned are: wheatflour, flour or meal from rice, potato, millet, rye, oats, barley, corn, tapioca and soya starch, or other suitable types of flour or meal; or a suitable combination thereof.

Starch constituents which may be mentioned are: corn starch, modified starch or another suitable (source of) starch; or a suitable combination thereof.

The roux may furthermore contain one or more further additions which are known per se in a roux, such as herbs and spices; or a suitable combination thereof; in quantities which are known per se.

More particularly, the composition of the roux may be as follows:

| | | |
|---|---|---|
| fats or fat constituents: | 25-80% | by weight |
| flour or meal: | 15-50% | by weight |
| starch: | 5-25% | by weight |
| further additions: | 0-4% | by weight |

where the total of constituents will be 100% by weight, based on the roux.

The roux can be prepared by mixing the abovementioned constituents, particularly with heating, in particular at a temperature of at least 40° C., preferably at least 70 to 110° C., more particularly at approximately 110° C. Preferably, the constituents of the roux are kept at this temperature during mixing for no longer than 30 minutes, more preferably for no longer than about 10 minutes.

The roux obtained in this way can then be added as such to the processed cheese base, but may also be hardened first (i.e. by cooling) for (temporary) storage and then be added to a freshly prepared processed cheese base in order to prepare a cheese sauce according to the invention.

In this case, the roux will generally be fed to the mixer or processor containing the freshly prepared processed cheese base in grated, ground or other comminuted/broken-up form (with the processed cheese base—as mentioned above—preferably being kept at a temperature of more than about 40° C., preferably more than about 70° C., in particular at a temperature in the range from 85 to 110° C.); if appropriate with mixing or stirring. The roux and the processed cheese base may also be metered into a suitable mixture simultaneously, if appropriate with stirring.

During and/or after mixing of the processed cheese base and the roux, generally only mixing/stirring will take place, without any further heating. The final temperature of the mixture after the processed cheese base and the roux have been mixed will generally be approximately 40-75° C.

The processed cheese base and the roux will generally be mixed in a weight ratio of 95:5 to 5:95, in particular in a weight ratio of 90:10 to 50:50.

If appropriate, yet further desired constituents, such as herbs, spices and flavourings in suitable quantities, may be added while the processed cheese base and the roux are being mixed.

The composition of the resultant mixture of the processed cheese base and the roux may be as follows:

| | | |
|---|---|---|
| cheese or cheese constituents: | 1-95% | by weight, preferably |
| | 40-95% | by weight |
| processing salts: | 0.05-4% | by weight, preferably |
| | 1-4% | by weight |
| binder: | 2-15% | by weight |
| preservative: | 0-0.25% | by weight |
| (constituents of the) roux: | 5-95% | by weight |
| in which: | | |
| fats or fat constituents: | 25-80% | by weight |
| flour or meal: | 15-50% | by weight |
| starch: | 5-25% | by weight |
| further additions: | 0-30% | by weight |

where the total of the constituents will be 100% by weight, based on the mixture of the processed cheese base and the roux.

It will be clear to the person skilled in the art that all the abovementioned constituents of the cheese sauce according to the invention must be suitable for use in foodstuffs and must preferably be able to combined with the other constituents of the mixture.

The mixture thus obtained is then hardened, for example by allowing the mixture—if appropriate after it has been moved from the processor into a suitable container—to cool from the mixing temperature to a temperature of 25° C. or below, in particular a temperature of approximately 0 to 10° C., for example for a period of 24 to 48 hours, if appropriate in a cold store.

The solidified mixture which is obtained in this way can then be comminuted/broken up in a suitable way, for example by breaking, chopping, cutting and preferably by grinding or grating at approximately 8° C. to form strands or a coarse or fine powder. The resultant product can then be packaged, for example in a bag, a box, a tin or another suitable container, and is sold as such. The product may, if appropriate, also be retailed as a frozen product, as a block or, for example, by freezing the powder or strands obtained after grating at a temperature of approximately −18 to −30° C.; if appropriate already in the container in which the powder will be sold.

The mixture obtained in the manner described above, if appropriate in the form of a packaged retail product and/or in the form of a frozen product, forms an important aspect of the present invention.

This mixture can then be processed or prepared further by the end user or consumer to form the final cheese sauce according to the invention. This will generally be carried out by mixing/reconstituting the mixture with water or with another suitable liquid, such as milk or wine, if appropriate by/with stirring or heating, for example in a heated water-bath (“bain-marie”) or in a microwave. The water will in this case be added in a suitable quantity, depending on the specific composition of the mixture and the desired end product, for example an amount of from 50 to 90% by weight water.

The cheese sauce according to the invention is then ready for consumption and can be served either hot or cold, although serving hot will generally be preferred.

If appropriate, the cheese sauce according to the invention may also be treated/processed further by the end user/consumer, for example by adding one or more desired further constituents or ingredients. It is also possible for the cheese sauce of the invention to be processed in or added to dishes by the end user/consumer.

It will therefore be clear to the person skilled in the art that the invention is not limited to any final use or any treatment/processing by the end user or the consumer, as long as the basis is the mixture described above and/or as long as the mixture described above is used. For example, the mixture described above and/or the cheese sauce according to the invention may also be used as a constituent involved in the (industrial) preparation of other food products, such as snacks, ready-to-eat meals, toppings and dressings and the like, which if appropriate are to be heated and/or treated/processed further prior to consumption.

The cheese sauce according to the invention (or the mixture described above) is in particular characterized by the presence of an amount of one or more processing salts, i.e. one or more of the processing salts mentioned above. More particularly, the processing salts will constitute 0.05 to 4%, based on the constituents of the mixture described above (i.e. without the water which is to be added by the end user and without any further constituents added by the end user).

Furthermore, compared to the known cheese sauces which are based on processed cheese (powder), the cheese sauce according to the invention (or the mixture described above) is characterized by the presence of (the one or more constituents of) the roux, in the quantities indicated above.

In addition, the cheese sauce according to the invention is preferably also characterized by a high level of cheese or cheese constituents, which may be 50% by weight or more, and even 70% by weight or more, based on the constituents of the mixture described above (i.e. without the water which is to be added by the end user and any further constituents added by the end user).

The following non-limiting example explains the invention in more detail.

### EXAMPLE

A processed cheese (base) was prepared from 673.4 kg of fresh, minced Maaslander, 8.7 kg of Solva 35; 8.7 kg of Solva 120; 111.3 kg of water; 1.9 kg of potassium sorbate and 41.7 kg of sodium caseinate. The preparation was carried out by mixing the constituents in a processor, while heating using direct steam at a temperature of 85-110° C., until a homogeneous mixture was obtained.

A roux was prepared from 61.6 kg of palm oil with a melting point of approximately 35° C., 20.8 kg of Rafel C (a hardened fat fraction produced by Karlshamus with a melting point of approximately 50-60° C.), 46.5 kg of wheatflour and 25.4 kg of corn starch.

The constituents of the roux were mixed by stirring while heating at approximately 110° C. (for no longer than 10 minutes). Then, the roux was cooled and grated.

The processed cheese base and grated roux were fed to a mixing vessel and mixed, with the temperature of the mixture being kept at approximately 60-70° C., without reheating. In this example, 154.3 kg of the roux was added to the total of the abovementioned constituents of the processed cheese base.

The mixture obtained in this way was filled directly into a container and hardened by cooling to a temperature of approximately 2° C. for approximately 48 hours. The mixture was then grated at approximately 8° C. and packaged in bags.

The resultant mixture was mixed with water, milk or wine, with heating and stirring, resulting in a cheese sauce according to the invention. The sauce was homogeneous without any lumps.

1. Method for preparing a cheese sauce and/or a cheese-based mixture which is suitable for the preparation of a cheese sauce by an end user/consumer, which method comprises at least the following steps:
a) producing a processed cheese base, in particular a processed cheese base which is based on fresh cheese;
b) mixing the processed cheese base from step a) with a roux.

2. Method according to claim 1, in which the processed cheese base produced in step a) is used for step b) while this base is kept at a temperature of at least 40° C., preferably of at least 70° C., and for preference at a temperature of 85 to 110° C.

3. Method according to claim 2, which method comprises, after the roux and the processed cheese base have been mixed, the following further steps:
c) hardening the mixture obtained in step b); and/or
d) comminuting/breaking up the mixture obtained in step b) or step c).

4. Method according to one of the preceding claims, in which the processed cheese base produced in step a) has the following composition:

| | | |
|---|---|---|
| cheese or cheese constituents: | 1-95% | by weight, preferably |
| | 40-95% | by weight |
| processing salts: | 1-4% | by weight |
| binder: | 2-15% | by weight |
| preservative: | 0-0.25% | by weight |
| water (added) | 0-20% | by weight |
| further additions: | 0-30% | by weight |

where the total of the constituents will be 100% by weight, based on the processed cheese base.

5. Method according to one of the preceding claims, in which the processed cheese base is prepared on the basis of fresh cheese or cheese constitutes.

6. Method according to one of the preceding claims, in which the processed cheese base is prepared on the basis of Maasslander, Gouda, Edam, Cheddar, Emmenthal, Gruyere, blue cheeses such as Roquefort, Gorgonzola, Danish Blue.

7. Method according to one of the preceding claims, in which the roux used in step b) has the following composition:

| | | |
|---|---|---|
| fats or fat constituents: | 25-80% | by weight |
| flour or meal: | 15-50% | by weight |
| starch: | 5-25% | by weight |
| further additions: | 0-4% | by weight |

where the total of constituents will be 100% by weight, based on the roux.

8. Method according to one of the preceding claims, in which the processed cheese base and the roux are mixed in a weight ratio of 95:5 to 5:95, in particular in a weight ratio of 90:10 to 50:50.

9. Method according to one of the preceding claims, comprising the following further steps:
e) the addition of water or another suitable liquid to the mixture from step b), step c) or step d); if appropriate while
f) stirring and/or heating; so as to produce a cheese sauce.

10. Method according to claim 9, in which the steps e) and f) are carried out by the consumer/end user, in particular immediately prior to consumption.

11. Mixture of a processed cheese base and a roux, from which a cheese sauce can be formed by adding water and, if appropriate, by stirring and/or heating, which mixture is/can be obtained using the method from one of claims 1-6.

12. Mixture according to claim 11, which has the following composition:

| | | |
|---|---|---|
| cheese or cheese constituents: | 1-95% | by weight, preferably |
| | 40-95% | by weight |
| processing salts: | 0.05-4% | by weight, preferably |
| | 1-4% | by weight |
| binder: | 2-15% | by weight |
| preservative: | 0-0.25% | by weight |
| (constituents of the) roux: | 5-95% | by weight |
| in which: | | |
| fats or fat constituents: | 25-80% | by weight |
| flour or meal: | 15-50% | by weight |
| starch: | 5-25% | by weight |
| further additions: | 0-30% | by weight |

where the total of the constituents will be 100% by weight, based on the mixture of the processed cheese base and the roux.

13. Mixture according to claim 11 or 12, in the form of a powder, if appropriate a frozen powder.

14. Mixture according to one of claims 11-13, in the form of a packaged product, in a suitable container, such as a bag, tin or box.

15. Cheese sauce which is/can be obtained using the method from claim 9 or 10, and/or which is obtained from a mixture according to one of claims 11-14.
